(19) United States
(12) Patent Application Publication
(10) Pub. No.: US 2026/0018052 A1
(43) Pub. Date: Jan. 15, 2026

(54) METHOD OF SITUATION-SPECIFIC DOCUMENTATION OF A TRAFFIC SITUATION IN WHICH A MOTOR VEHICLE IS LOCATED, A CONTROL DEVICE, A STORAGE MEDIUM, A MOTOR VEHICLE, AND A SERVER APPARATUS

(71) Applicant: AUDI AG, Ingolstadt (DE)

(72) Inventor: Frank HENECKER, Ernsgaden (DE)

(73) Assignee: AUDI AG, Ingolstadt (DE)

(21) Appl. No.: 19/269,962

(22) Filed: Jul. 15, 2025

(30) Foreign Application Priority Data
Jul. 15, 2024 (DE) 10 2024 120 027.8

(51) Int. Cl. G08G 1/01; G06V 20/58; G07C 5/00

(52) U.S. Cl. CPC G08G 1/0133; G06V 20/582; G07C 5/008; G08G 1/0112

(57) ABSTRACT

A method of situation-specific documentation of a traffic situation in which a motor vehicle is located. A control device receives, from a monitoring device, monitoring data which describes a current traffic situation in which the motor vehicle is located, and driving data, from at least one motor vehicle system of the motor vehicle, which describes at least one driving parameter for a current driving behavior of the motor vehicle. The control device determines an extended traffic situation on the basis of the received data and checks whether the extended traffic situation meets a specified danger criterion which specifies a minimum probability of damage occurring to the motor vehicle. Based on the extended traffic situation meets the specified danger criterion, the control device provides an analysis data set which describes the a result of the checking, and causes a documentation device to store the provided analysis data set.

### CROSS REFERENCE TO RELATED APPLICATIONS

This application is a based upon and claims the priority benefit of German Application No. 10 2024 120 027.8 filed on Jul. 15, 2024, the entire contents of which are incorporated by reference herein.

### BACKGROUND

### 1. Field

Disclosed herein is a method for the situation-specific documentation of a traffic situation in which a motor vehicle is located, a control device, a storage medium, a motor vehicle, and a server apparatus.

Nowadays, many vehicles already have camera-based traffic sign recognition. In addition, radar and lidar sensor systems are installed among other things for autonomous and semi-autonomous driving, which sensor systems are used, for example, for object recognition.

### 2. Description of the Related Art

DE 10 2021 212 160 A1 describes a safety apparatus for a vehicle for detecting and assessing dangerous traffic situations, having a sensor interface for connecting different vehicle sensors to the safety apparatus, an evaluation unit for processing sensor information from different vehicle sensors, a buffer memory for buffering sensor information, and an active memory for storing sensor information and/or results of the assessment of sensor information. The evaluation unit has at least two switching states, namely a standby state and an active state, and is able to be switched from the standby state to the active state if at least one safety violation indication by other road users in the vicinity of the vehicle has been recognized by the evaluation unit on the basis of sensor information.

DE 10 2004 015 221 A1 discloses an event data recorder for documenting events, in particular for documenting traffic events, which comprises at least one recording unit for recording event data units of events.

DE 10 2018 210 852 A1 describes a method for determining illegal driving behavior of at least one road user in an environment of a vehicle, wherein the environment is detected by vehicle sensors, an environment model is created on the basis of the sensor data from the vehicle sensors, illegal behavior by the at least one road user is recognized from the environment model, the sensor data are stored as evidence in a time window of the recognized illegal behavior.

It is disadvantageous here that it is not possible to systematically refer to documentation, in order, for example, to preserve evidence, or in order to be able to subsequently evaluate the traffic situation.

### SUMMARY

An aspect of the invention enables evidence preservation and subsequent evaluation of a traffic situation.

According to another aspect, the stated object is achieved in each case by the inventive method and the inventive apparatuses according to the alternative independent claims. Advantageous developments are provided by the dependent claims

An aspect of the invention is based on the idea of using a sensor system for driver assistance systems, for example a sensor system for traffic sign recognition and/or object recognition, and of enhancing it with driving data of the vehicle, for example with data describing the speed, acceleration and/or deceleration, and/or steering wheel position. An analysis of these data is documented by a system decoupled from the driver assistance system and preferably external to the motor vehicle and can be used to preserve evidence, to subsequently evaluate the traffic situation and to check the quality of the driver assistance system of the motor vehicle.

This thus advantageously enables a way of objectively observing a dangerous situation and thus, for example, a collection of evidence in the event that damage occurs. A quality check is thus made possible, which, provided that the method is supplemented by artificial intelligence, detects even small errors and interrelationships better than a human analyst. The optional implementation of artificial intelligence, that is to say a neural network, has the advantage over plain vehicle software that the artificial intelligence can automatically process a much higher number of patterns and also analyze unknown situations.

In the event of accidents, accurate documentation of the course of events is also important to clarify the latter. In contrast to witness statements, which can often be subjective and also fuzzy as time passes, the documentation of the method according to an aspect of the invention provides factual documentation as opposed to subjective statements such as, for example, “the motor vehicle decelerated quickly/slowly”.

In other words, the core of the invention according to an aspect is carrying out automatic evidence preservation for the documentation for example by means of traffic sign and/or object recognition, which is supplemented by driving data. A bundled data set is then analyzed, for example categorized as to whether a dangerous situation exists or not. If a danger is recognized, the bundled data set can be forwarded to a data server external to the motor vehicle, for example. Further applications of the documentation are a reduction in the risk of an accident owing to the accident documentation, for example, with the documentation being used to check the quality of existing systems, in particular to check the quality of the driver assistance system of the motor vehicle.

The inventive method for the situation-specific documentation of a traffic situation in which a motor vehicle is located is carried out by a control device.

A control device is understood to mean a device, a device component or a device group which is configured to receive signals, evaluate them and to generate control signals. The control device can be configured, for example, as a control unit or control chip. For this purpose, the control device can have a receiving module and a transmitting module. A control device, preferably internal to the motor vehicle, can be configured, for example, as a control unit or control chip and have, for example, one or more processor devices having, for example, one or more microprocessors, and/or a data memory.

The control device receives monitoring data from a monitoring device of the motor vehicle, which monitoring data describe a current traffic situation in which the motor vehicle is located. For this purpose, the monitoring data can describe the entire traffic situation, or, by way of example, individual aspects in each case, for example the position and number of other road users in a specified radius around the motor vehicle, traffic light control, and/or data about the routes and speeds of other motor vehicles.

A monitoring device is understood to mean a device, a device component or a device group which is configured and set up to monitor an environment of the motor vehicle. For this purpose, the monitoring device can, for example, have one or more sensors, for example cameras and/or proximity sensors, and/or a data receiving module for receiving data from an Internet or mobile phone connection. Optionally, the control device can receive the monitoring data from the driver assistance system of the motor vehicle.

The control device furthermore receives driving data from at least one motor vehicle system of the motor vehicle, which driving data describe at least one driving parameter for a current driving behavior of the motor vehicle. The driving data can, for example, describe a speed of the motor vehicle, data about an acceleration of the motor vehicle and/or about a deceleration of the motor vehicle, and/or about a steering wheel position of the motor vehicle. The motor vehicle system, from which the control device receives the driving data, can then be, for example, a longitudinal and/or transverse control means of the motor vehicle, or an on-board computer of the motor vehicle.

The control device determines an extended traffic situation on the basis of the received monitoring data and the received driving data. The extended traffic situation integrates the driving behavior of the motor vehicle into a model of the current traffic situation. The “extended traffic situation” is thus a traffic situation specific to the motor vehicle, in which not only the data of the monitoring device are represented but in which the driving behavior of the motor vehicle is also represented. This allows an influence of the motor vehicle on the other road users and an influence of the current traffic situation on the motor vehicle to be deduced. The extended traffic situation is thus a dynamic model.

The control device checks the extended traffic situation as to whether it meets a specified danger criterion which specifies a minimum probability which a minimum probability of damage occurring to the motor vehicle. The specified danger criterion can, for example, define a percentage as a threshold value, above which damage to the motor vehicle—or additionally even to another road user—is probable. Optionally, the specified danger criterion can describe a minimum probability of an accident of the motor vehicle with damage to the motor vehicle, or the minimum probability of damage to the motor vehicle.

If the extended traffic situation meets the specified danger criterion, the control device provides an analysis data set. The provided analysis data set describes a description of the comparison result. Consequently, an analysis that is independent of the driver assistance system is thus provided.

The control device causes a documentation device to store the provided analysis data set. The documentation device can be located in the motor vehicle or in a server external to the motor vehicle, or partly in the motor vehicle and partly in the server external to the motor vehicle. In order to conserve data rate, mobile phone rate and/or costs, preferably only data that are relevant for further processing can be forwarded to the server apparatus external to the motor vehicle. Likewise, the analysis data set can is stored partially in the motor vehicle and partially in the server external to the motor vehicle. Alternatively, the analysis data set can be stored in the motor vehicle or in the server external to the motor vehicle in dependence on a specified condition.

The advantages mentioned above arise.

A documentation device is understood to mean a device, a device group or a device component which is configured to document data. The documentation device can therefore preferably be configured as a data memory or storage medium.

Preferably, the monitoring data can describe data about traffic sign recognition and/or object recognition. Consequently, the quality check is carried out in particular for functionalities for assessing traffic situations with, for example, other road users and/or speed limits. If traffic sign recognition of the motor vehicle recognizes, for example, a speed limit of 60 kilometers per hour, the quality check of the method according to an aspect of the invention can allow traffic sign recognition to be optimized if, for example, the traffic sign recognition has incorrectly recognized a speed limit label on the rear of a truck, or has incorrectly recognized a speed limit for a highway exit while the motor vehicle continues to remain on the highway.

In one preferred embodiment of the method according to an aspect of the invention, the control device can receive driver assistance data from the driver assistance system of the motor vehicle, which driver assistance data describe an analysis result of the driver assistance system about the current driving behavior of the motor vehicle in the current traffic situation. The driver assistance data can, in other words, describe that which the driver assistance system has calculated for the situation of the motor vehicle and the traffic situation. Optionally, the driver assistance data can additionally describe information about an intervention of the driver assistance system in the driving behavior of the motor vehicle, that is to say, for example, control data for automatic deceleration and/or control data for steering the motor vehicle.

The control device can compare the analysis result of the driver assistance system with the checking result. In other words, the control device can compare the analysis result of the driver assistance system with its own checking result. If the extended traffic situation meets the specified danger criterion and a comparison result reveals that the analysis result of the driver assistance system and the analysis of the control device are different, the control device can provide a configuration data set which can describe, for example, a provided control proposal of the control device in response to the extended traffic situation, or an improved control proposal worked out by a neural network. Preferably, a specified tolerance range can optionally be observed here.

The control device can then transmit the provided configuration data set to the driver assistance system and/or to a configuration device external to the motor vehicle. The configuration data set can be used to configure and improve not only the driver assistance system of the motor vehicle but also driver assistance systems of other motor vehicles. The quality check and the subsequent configuration can allow the quality of the driver assistance system or the driver assistance systems to be consistently improved.

In one example, the control device may determine that the driver assistance system of the motor vehicle has come to the same result. In another example, the driver assistance system may, for example, have intervened too early, or the driver assistance system could, for example, have also initiated less abrupt deceleration instead of emergency deceleration in order to safely avert a dangerous situation.

In addition to the quality check, precision of the driver assistance system can thus be improved. This embodiment of the method according to an aspect of the invention can therefore also be referred to as a method for the traffic situation-specific checking of the driver assistance system of a motor vehicle, or as a method for the traffic situation-specific configuration of a driver assistance system of the motor vehicle.

Preferably, the control device can transmit the received monitoring data and the received driving data to a deep learning engine. A deep learning engine (“deep learning device”) is a device, a device component or a program which can apply so-called deep learning (machine learning) to a multiplicity of data. In other words, the deep learning engine is a sophisticated device for carrying out deep learning, that is to say an implementation of artificial intelligence. In other words, the deep learning engine can be used to implement artificial intelligence as well as machine learning and deep learning. The deep learning engine can, for example, be designed and/or configured as a deep, artificial neural network. In other words, the deep learning engine can be set up to use a machine learning method to evaluate a multiplicity of empirical values and/or training data, which can also be referred to as a training data set, or a data set according to a predetermined algorithm and on the basis of the already stored multiplicity of empirical values, for example via logic contained therein, for example a correlation. Further logical links can thus also be created in the deep learning engine.

In this case, empirical values or training data can then be statistically summarized, for example, for a multiplicity of monitoring data and driving data—that is to say also for a multiplicity of different traffic situations, for values of a probability of damage to or an accident involving the motor vehicle.

In this embodiment of the method according to an aspect of the invention, the control device can operate the deep learning engine such that the deep learning engine statistically summarizes values of values of a probability of damage to the motor vehicle for a multiplicity of traffic situations. The control device can also operate the deep learning engine to process the traffic situation described by the received monitoring data and the received driving data and to thereby determine a damage forecast. In this case, the damage forecast comprises a probability of damage occurring to the motor vehicle.

The control device can then operate the deep learning engine to provide the checking result on the basis of the damage forecast.

This embodiment of the method according to an aspect of the invention makes the checking and thus the analysis result much more accurate, and the method is also able to be much better applied to unknown traffic situations. The advantages mentioned above are thus synergistically enhanced. The advantages of using a neural network have also already been discussed above.

For application cases or application situations which can arise in the method and which are not explicitly described here, provision can be made for an error message and/or a request for input of a user acknowledgement to be issued according to the method and/or for a default setting and/or a predetermined initial state to be set.

According to an aspect of invention, a control device for the motor vehicle, which is set up to carry out an embodiment of the method according to the invention, is provided. The control device can have a data processing device or a processor device (processor circuit). The processor device can have at least one microprocessor and/or at least one microcontroller and/or at least one FPGA (Field Programmable Gate Array) and/or at least one DSP (Digital Signal Processor) for this purpose. In particular, a CPU (Central Processing Unit), a GPU (Graphical Processing Unit) or an NPU (Neural Processing Unit) can each be used as a microprocessor. Furthermore, the processor device can have a program code which is set up to carry out the embodiment of the method according to an aspect of the invention upon execution by the processor device. The program code can be stored in a data memory of the processor device. The processor device can be based, for example, on at least one circuit board and/or on at least one SoC (System on Chip).

As a further solution, an aspect of the invention also comprises a computer-readable storage medium comprising a program code which, when executed by a computer or a computer network, causes the latter to perform an embodiment of the method according to the invention. The storage medium can be provided at least partially as a non-volatile data memory (for example as a flash memory and/or as an SSD—solid state drive) and/or at least partially as a volatile data memory (for example as a RAM—random access memory). The storage medium can be arranged in the computer or computer network. The storage medium can, however, also be operated, for example, as a so-called app store server and/or cloud server on the Internet. A processor circuit having, for example, at least one microprocessor can be provided by the computer or computer network. The program code can be provided as binary code and/or as assembly code and/or as source code of a programming language (for example C) and/or as a program script (for example Python). The computer-readable storage medium can alternatively be implemented by a signal having computer-readable data, for example a time-varying voltage signal and/or a radio signal.

The object stated above is achieved by a server apparatus for operating on the Internet, for example a data server, a backend and/or a data cloud, wherein the server apparatus has an embodiment of the storage medium according to an aspect of the invention and/or an embodiment of the control device according to an aspect of the invention.

The invention also includes developments of the control device according to an aspect of the invention, of the storage medium according to the invention, of the motor vehicle according to the invention, and of the server apparatus according to the invention, which have features as have already been described in connection with the developments of the method according to an aspect of the invention. For this reason, the corresponding developments of the control device according to an aspect of the invention, of the storage medium according to the an aspect of invention, of the motor vehicle according to an aspect of the invention, and of the server apparatus according to the invention, are not described again here.

The object stated above is also achieved by the motor vehicle according to an aspect of the invention, which has an embodiment of the control device according to an aspect of the invention. The motor vehicle according to an aspect of the invention is preferably in the form of a motorized vehicle, in particular of a passenger car or truck, or of a minibus or motorcycle.

The invention, according to an aspect, also comprises the combinations of the features of the embodiments described. An aspect of the invention thus also comprises implementations each having a combination of the features of several of the embodiments described, provided that the embodiments have not been described as mutually exclusive.

Exemplary embodiments of the invention are described below. For this purpose, the single FIGURE (“FIG. 1”) shows a schematic illustration of an exemplary embodiment of the method according to the invention and of the apparatuses according to the invention.

The exemplary embodiments explained below are preferred embodiments of the invention. In the exemplary embodiments, the described components of the embodiments each represent individual features of the invention which are to be considered independently of each other and in each case also develop the invention independently of each other. Therefore, the disclosure is intended to also comprise combinations of the features of the embodiments other than those illustrated. Furthermore, the embodiments described can also be supplemented by further ones of the already described features of the invention.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 shows an exemplary motor vehicle which can be in the form of a passenger car, for example, according to an aspect of the invention.

### DETAILED DESCRIPTION

Reference will now be made in detail to the preferred embodiments, examples of which are illustrated in the accompanying drawings, wherein like reference numerals refer to like elements throughout.

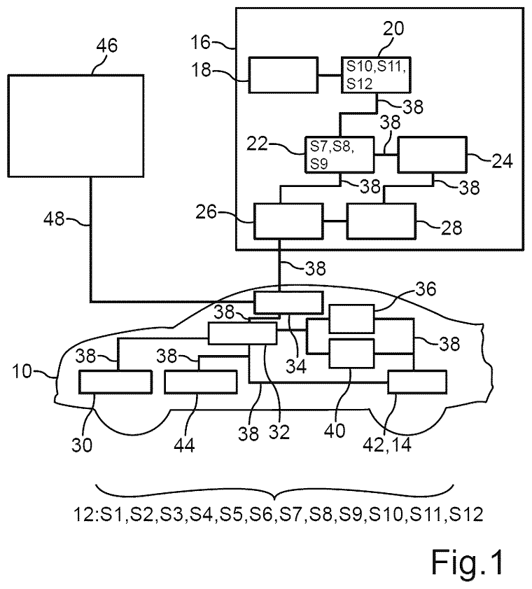

In FIG. 1, identical reference signs each refer to elements having the same function.

An optional storage medium 14 on which a program code for carrying out the method according to the invention can be stored can be integrated in the motor vehicle in addition to or alternatively to the control device 12. FIG. 1 also shows the alternative in which subcomponents and thus subtasks of the control device 12 are allocated to the motor vehicle 10 and the server apparatus 16.

As an alternative to the example shown in FIG. 1, the control device 12 can be a component only of a server apparatus 16 external to the motor vehicle. The server apparatus 16 can be configured, for example, as a cloud system, and in addition to or alternatively to the control device 12 have a storage medium 14 as described above.

The storage medium can be configured, for example, as a memory card, hard disk or memory chip.

FIG. 1 shows an exemplary configuration of a server apparatus 16 having the following optional components which may be present in the combination shown or in a combination of fewer than the components shown. The components shown by way of example in FIG. 1 are a secure interface 18 which can be set up to govern access to data in the server apparatus 16. For example, provision can thus be made for only a user of the motor vehicle 10 and/or a manufacturer or supplier of the motor vehicle 10 to have access to the data, and/or a public authority.

In addition or alternatively, the server apparatus 16 can optionally have “dangerous situation protection” 20, a “dangerous situation analysis unit” 22, a “software development unit” 24, a “transmitting and receiving system” 26, and/or “repository function software” 28. These components are described in more detail below.

In an optional example, as shown by way of example in FIG. 1, the control device 12 can have one or more of the following subcomponents of the motor vehicle 10: A “geo-positioning system” 30, a “central management unit” 32, a “transmitting and receiving system” 34, a “system for avoiding or reducing dangers” 36, a “monitoring device” 40, which can also be referred to as a “monitoring unit”, and a cyclic memory 42. In the illustration of the motor vehicle 10, actuators and/or sensors and/or software functions 44 are also shown in this case. These subcomponents can also be referred to as “system of the motor vehicle 10”.

The documentation device can preferably have a motor-vehicle-side component or motor-vehicle-side components, and a server-side component or server-side components. In one example, the documentation device can comprise a storage medium 14 which can preferably be configured as a cyclic memory 42. In addition or alternatively, the documentation device can comprise a storage medium 14 on the server side.

Data communication connections 38 can be wired data communication connections, preferably for data communication within the motor vehicle system or within the server system, and be configured as a data bus, for example. The data communication connection 38 between motor vehicle 10 and server apparatus 16 can preferably be a wireless data communication, for example a mobile phone connection or Internet connection.

The above-described optional assembly of subcomponents in the motor vehicle 10 and in the server apparatus 16 is exemplary. The individual subcomponents are described in more detail below for a further exemplary embodiment.

In a first operation S1, the monitoring device 40, which can also be referred to as a “monitoring unit”, receives monitoring data which describe a current traffic situation. In particular, the monitoring device 40 can comprise a sensor system for traffic sign recognition and/or for object recognition. In addition or alternatively, the monitoring device 40 can, for example, retrieve current traffic data from a server external to the motor vehicle.

The monitoring can preferably be carried out continuously, that is to say the monitoring device 40 can receive or retrieve the monitoring data continuously, or the received monitoring data can describe the current traffic situation continuously over time.

In one example, the motor vehicle 10 can be traveling on a highway at a speed of 100 kilometers per hour, for example. At the level of a highway exit, the monitoring device 40 can, for example, receive monitoring data describing a speed limit sign for a maximum of 120 kilometers per hour on the car section, and a speed limit sign for 60 kilometers on the right-hand side of the exit. The driving data received in S2 from, for example, an on-board computer of the motor vehicle 10 can describe that the driver is not carrying out a steering movement and also is not actuating the turn signal, that is to say is not intending to leave the highway. Optionally, such received driving data, for example driving data from a navigation device, can describe that a route of the motor vehicle 10 runs straight ahead at this point, thus that the motor vehicle 10 is remaining on the highway.

In S3, the control device 12 determines, for example with the aid of the “system for avoiding dangers” 36, an extended traffic situation, that is to say, for example, a model of the current traffic situation, which integrates the motor vehicle 10 with its route and characteristics of its current movement. In S4, the control device 12 checks whether the exemplary model of the extended traffic situation meets a specified danger criterion.

This can optionally be implemented with the aid of a neural network of a deep learning engine 46. In this case, the deep learning engine 46 is shown by way of example as a component external to the motor vehicle but can alternatively be a component of the server apparatus 16, or of the motor vehicle 10, in particular of the control device 12. In the example of FIG. 1, the communication with the deep learning engine 46 can take place by way of example via an Internet connection 48 to the transmitting and receiving system 34.

Training data or empirical values, with which such a deep learning engine 46 may have been trained, can preferably be summarized as an artificial neural network, and for example come from a database. Preferably, such data about monitoring data and driving data may be/have been used in a number of >1000, in particular >10 000, for training the deep learning engine 46, wherein the training data have preferably been acquired over a predetermined observation period. Such a data set can be referred to as a big-data data set.

In this case, each empirical value can, for example, be a combination of a traffic situation and the corresponding value of a probability of damage to the motor vehicle 10. An empirical value is thus understood to mean a value or an indication which, for example, based on empirical measurements or investigations, makes a statement as to whether, for example, the minimum probability specified by the specified danger criterion has been exceeded.

The empirical value can thus, for example, be a numerical value or an assignment value. An empirical value is also understood to mean a functional dependence or a functional assignment, which makes a statement about whether or in which traffic situation which probability exists that damage to the motor vehicle will occur and/or an accident will happen. An empirical value can therefore also be understood, in other words, to mean a rule for the assignment based on numerical values.

After the control device 12 has transferred the monitoring data and the driving data to the deep learning engine 46 (S5), the control device 12 operates the deep learning engine 46 in S6 to provide the damage forecast.

In the example of FIG. 1, a driver assistance system (not shown in FIG. 1) of the motor vehicle 10 can, for example, only read the traffic sign of the highway exit, and incorrectly assume a spontaneous speed reduction to 60 kilometers per hour on the highway section. The driver assistance data provided by the driver assistance system can describe the analysis result of the driver assistance system and its response, harsh deceleration to 60 kilometers per hour. In the model of the extended traffic situation of the control device 12 shown, this harsh deceleration may meet the specified danger criterion without the motor vehicle 10 decelerating during its further journey on the highway.

The optional reception S7 of the driver assistance data can take place, for example, via a data bus of the motor vehicle 10. Based on the determined danger that the deceleration to 60 kilometers per hour may not be sensible or may even be dangerous, the control device 12 in S8 provides a configuration data set to be transmitted S9 to the driver assistance system and/or to a configuration device (not shown in FIG. 1) external to the motor vehicle. A configuration device is understood to mean a device, a device component or a device group which is set up to make adjustments to a specified set of configuration data on the driver assistance system.

In the example in which the control device 12 recognizes a traffic situation which reaches or exceeds the minimum probability for the risk of damage to the motor vehicle or to another road user, the control device 12 in S10 provides an analysis data set which describes the checking result and preferably also the input data and the model of the extended traffic situation. In S11, the control device 12 causes a documentation device to store the provided analysis data set in a data storage device, that is to say, for example, a storage medium 14 external to the motor vehicle. If an accident has occurred, these data are provided for subsequent evaluation.

In another example, the driver assistance system may, in other words, have initiated, for example, emergency deceleration but a check S4 may reveal that the entirety of all the data from the consulted sensors has not reported any danger. One reason for this could be, for example, that data was reported to the driver assistance system too slowly.

Overall, the examples show how a method for automatic evidence preservation in dangerous situations can be provided for autonomous and non-autonomous vehicles, for example.

Preferably, the sensor system for the traffic sign recognition and/or object recognition can be used to form an extensive picture of the current situation around the motor vehicle 10, enhanced with further driving data which are already available, such as preferably speed, acceleration/deceleration, and/or steering wheel position. This will then preferably be stored in the vehicle (preferably in real time) and/or externally (preferably cyclically) in order to document evidence.

In a system description according to a further exemplary embodiment, the new system can preferably have the system of the motor vehicle 10 shown in FIG. 1 and the exemplary cloud system.

The system of the motor vehicle 10 can optionally have one or more of the subcomponents “transmitting/receiving unit” 34, “central management unit” 32, “monitoring device” 40, “cyclic memory” 42, “system for avoiding or reducing dangers” 36 and “geo-positioning system” 30. The subcomponents can each be allocated to their own components but do not have to be. In addition or alternatively, the motor vehicle 10 can have a display device (not shown in FIG. 1) for displaying information, for example an HMI component (“Human Machine Interface”, “HMI”).

The server apparatus 16, for example a cloud system, can optionally have one or more of the subcomponents “transmitting and receiving unit” 26, “dangerous situation analysis unit” 22, “repository function software” 28, “dangerous situation protection” 20 and/or a “secure interface” 18.

Each system can itself be optionally tamper-protected according to measures known from the prior art, and preferably all internal communication can be cryptographically encrypted.

In a method description according to a further exemplary embodiment, which can be combined with other exemplary embodiments, the method can be divided into a plurality of substeps:
Monitoring the vehicle environment (S1),
Recognizing dangerous situations,
Documentation in the motor vehicle 10,
Documentation, preferably in a server apparatus 16 external to the motor vehicle,
optionally deleting the documentation, and/or
Decentralized outsourcing.

### Substep “Monitoring the Vehicle Environment” (S1, S2)

The vehicle system continuously monitors the vehicle environment in the “monitoring unit”.

For this purpose, it can preferably collect:
the data, for example, of a traffic sign recognition camera (referred to generally as “actuators/sensors” in the technical illustration), that is to say the dynamic and the processed image data and the recognized traffic signs,
the object recognition(s) carried out by the radar sensor system and/or lidar sensor system (referred to generally as “actuators/sensors” in the technical illustration),
and/or all the variables relevant for assessing and/or preserving evidence, such as, for example, absolute and relative speeds with respect to objects and/or of the motor vehicle 10 and/or also pedal positions, steering wheel position, geo-positioning (for example GPS, GLONASS), and/or active and passive safety measurement data.

### Substep “Recognizing Dangerous Situations” (S3, S4)

The “system for avoiding or reducing dangers” 36 in the vehicle system analyzes the information collected in the substep “monitoring the vehicle environment” (S1) and qualifies each related data set in terms of the criticality of the situation.

Further processing, for example initiating an alternative measure “emergency flashing” or “emergency deceleration” or else displaying via an HMI component this assessment thus obtained to avoid or reduce dangers, may only be an optional part of the method.

### Substep “Documentation in the Motor Vehicle 10” (S10, S11)

The data sets thus acquired from the substeps “monitoring the vehicle environment” (S1) and “recognizing dangerous situations” are stored in a system “cyclic memory” 42 in the vehicle system, preferably cyclically and ideally with a unique time stamp.

### Substep “Documentation in the Server Apparatus 16 External to the Motor Vehicle” (S10, S11)

If the “system for avoiding or reducing dangers” 36 recognizes, via the crash sensors connected thereto or also unusual changes in absolute or relative speeds with respect to recognized objects or in general, then the situation criticality switches to crash and this trigger immediately starts the transmission, via the “transmitting/receiving unit” 34 in the vehicle system and/or in the exemplary cloud system, of the contents of the “cyclic memory” 42 in the exemplary cloud system to the “dangerous situation protection” 20, in the event, for example, of an improvement of alternative measures, of the recognized crash. Otherwise, the data can be transmitted cyclically, in order, for example, to thus further train the optional neural network anonymously with new data.

### Substep “Evaluating for Improvement” (S7, S8, S9)

In the exemplary cloud system, the transmitted data can optionally be stored for vehicle identification and analyzed by the “dangerous situation analysis unit” 22 in order to recognize potentially false positive assessments of a crash of the “system for avoiding or reducing dangers” 36. These findings can preferably be used automatically as learning data for the optionally underlying artificial intelligence and integrated into the next update of the “system for avoiding or reducing dangers” 36, which can then be distributed via the “repository function software” 28.

### Substep “Deleting the Documentation”

Optionally, in the “cyclic memory” 42 of the motor vehicle system, the entries with the oldest time stamp can be overwritten (S12) when/if the cyclic memory 42 is full, and/or after a specified maximum storage time has expired. This can be done using standardized, already established methods. The contents stored in the exemplary cloud system as a server apparatus 16 can preferably be deleted automatically according to specified rules and retention periods.

Due to data protection or in order to conserve a data memory, for example, a preferably cyclical overwriting of non-relevant data can take place, in order, for example, not to constantly monitor a driver of the motor vehicle 10. By way of example, only the last 30 seconds prior to an accident can be stored by a data inventory, and/or the data can only be stored for a predetermined period of time

### Substep “Decentralized Storage”

Both authorized parties and authorized users can be given the opportunity to be able to retrieve the one or more relevant data sets stored in the exemplary cloud system about a vehicle system via a “secure interface” 18. Automated reconstructions of operations of all those involved in a dangerous situation can thus be carried out. This reconstruction is merely optional.

This advantageously enables, in addition to the advantages already mentioned above, authorized users with such stored data sets to be able to objectively observe a dangerous situation and a good collection of evidence is thus made possible.

One preferred technical implementation is shown in FIG. 1.

Preferably, the sensor systems for the traffic sign recognition and/or object recognition can be used to form an extensive picture of the current situation around the motor vehicle, preferably enhanced with further data already available today, such as, for example, speed, acceleration/deceleration, steering wheel position. This data set can then be stored in the motor vehicle 10 and/or in a server apparatus 16 external to the motor vehicle, for example, in order to preserve evidence.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1. A method of situation-specific documentation of a traffic situation in which a motor vehicle is located by a control device, the method comprising:
receiving monitoring data, from a monitoring device of the motor vehicle, which describes a current traffic situation in which the motor vehicle is located,
receiving driving data, from at least one motor vehicle system of the motor vehicle, which describes at least one driving parameter for a current driving behavior of the motor vehicle,
determining an extended traffic situation based on the received monitoring data and the received driving data and checking whether the extended traffic situation meets a specified danger criterion which specifies a minimum probability of damage occurring to the motor vehicle,
providing, based on the extended traffic situation meeting the specified danger criterion, an analysis data set which describes a result of the checking, and
causing a documentation device to store the provided analysis data set.

2. The method according to claim 1, wherein the monitoring data describe data about traffic sign recognition and/or object recognition.

3. The method according to claim 1, wherein the control device:
receives driver assistance data from a driver assistance system, which describes an analysis result of the driver assistance system about the current driving behavior of the motor vehicle in the current traffic situation,
based on the extended traffic situation meeting the specified danger criterion and a comparison result revealing that the analysis result of the driver assistance system and the analysis data set of the control device are different, provides a configuration data set which describes a control proposal of the control device based on the extended traffic situation, and
transmits the provided configuration data set to the driver assistance system and/or to a configuration device external to the motor vehicle.

4. The method according to claim 2, wherein the control device:
receives driver assistance data from a driver assistance system, which describes an analysis result of the driver assistance system about the current driving behavior of the motor vehicle in the current traffic situation,
based on the extended traffic situation meeting the specified danger criterion and a comparison result revealing that the analysis result of the driver assistance system and the analysis data set of the control device are different, provides a configuration data set which describes a control proposal of the control device based on the extended traffic situation, and
transmits the provided configuration data set to the driver assistance system and/or to a configuration device external to the motor vehicle.

5. The method according to claim 1, wherein the received driving data describe a current speed of the motor vehicle, data about an acceleration and/or a deceleration of the motor vehicle, and/or about a steering wheel position.

6. The method according to claim 2, wherein the received driving data describe a current speed of the motor vehicle, data about an acceleration and/or a deceleration of the motor vehicle, and/or about a steering wheel position.

7. The method according to claim 3, wherein the received driving data describe a current speed of the motor vehicle, data about an acceleration and/or a deceleration of the motor vehicle, and/or about a steering wheel position.

8. The method according to claim 1, wherein the control device:
transmits the received monitoring data and the received driving data to a deep learning engine;
operates the deep learning engine such that the deep learning engine statistically summarizes values of the probability of damage occurring to the motor vehicle for a multiplicity of traffic situations;
operates the deep learning engine to process the traffic situation described by the provided received monitoring data and the received driving data and to thereby determine a damage forecast, the damage forecast including the probability of damage occurring to the motor vehicle; and
operates the deep learning engine to provide a result of the checking based on the damage forecast.

9. The method according to claim 2, wherein the control device:
transmits the received monitoring data and the received driving data to a deep learning engine;
operates the deep learning engine such that the deep learning engine statistically summarizes values of the probability of damage occurring to the motor vehicle for a multiplicity of traffic situations;
operates the deep learning engine to process the traffic situation described by the provided received monitoring data and the received driving data and to thereby determine a damage forecast, the damage forecast including the probability of damage occurring to the motor vehicle; and
operates the deep learning engine to provide a result of the checking based on the damage forecast.

10. A control device which is set up to carry out the method according to claim 1.

11. The control device according to claim 10, which is set up to:
transmit the received monitoring data and the received driving data to a deep learning engine;
operate the deep learning engine in such a way that the deep learning engine statistically summarizes values of a probability of damage occurring to the motor vehicle for a multiplicity of traffic situations;
operate the deep learning engine in such a way as to process, by means of the deep learning engine, the traffic situation described by the provided received monitoring data and the received driving data and to thereby determine a damage forecast, wherein the damage forecast comprises the probability of damage occurring to the motor vehicle; and
operate the deep learning engine in such a way as to provide a result of the checking based on the damage forecast.

12. A non-transitory storage medium comprising a program code which, when executed by a computer or a computer network, causes the method according to claim 1.

13. A server apparatus for operating on the Internet, which has the control device according to claim 10 and/or the non-transitory storage medium according to claim 12.

14. A motor vehicle having the control device according to claim 10 and/or the non-transitory storage medium according to claim 12.
